(19) United States
(12) Patent Application Publication
(10) Pub. No.: US 2016/0256971 A1
(43) Pub. Date: Sep. 8, 2016

(54) INTERFACE APPARATUS OF TRANSMISSION

(71) Applicant: Chung-Yuan Christian University, Tao Yuan County (TW)

(72) Inventors: YUNG TING, Tao Yuan County (TW); SHEUAN-PERNG LIN, Tao Yuan County (TW); KAI-CHAO CHANG, Tao Yuan County (TW)

(21) Appl. No.: 14/728,478

(22) Filed: Jun. 2, 2015

(30) Foreign Application Priority Data
Mar. 5, 2015 (TW) 104107102

(51) Int. Cl. B23Q 5/04; F16C 19/06; B23B 37/00

(52) U.S. Cl. CPC B23Q 5/043; B23B 37/00; F16C 19/06; B23B 2270/10; B23B 2260/0085; B23B 2260/108

(57) ABSTRACT

An interface apparatus of transmission which can be installed in an ultrasonic vibration machining apparatus which includes a cutting tool and a piezoelectric vibration apparatus includes a fixed ring, a plurality of rotary bearing objects and a rotary ring. The fixed ring is used to connect the piezoelectric vibration apparatus and remains in a fixed state. The rotary ring is used to connect the cutting tool for machining. The plurality of rotary bearing objects are between the fixed ring and the rotary ring.

### BACKGROUND OF THE INVENTION

1. Field of the Invention

The present invention relates to an apparatus of transmission, especially an interface apparatus of transmission used in an ultrasonic machining apparatus.

2. Description of the Related Art

A general ultrasonic machining apparatus makes use of a piezoelectric material to create high-frequency vibrations. The piezoelectric effect occurs only during the transmission of electricity, so the design of electricity transmission is an important factor.

Basically, most methods of electricity conduction use a brush or a wire configuration to transmit electricity to the piezoelectric material. For example, the ultrasonic machining apparatus in CN 102989653A conducts electricity via a brush and a conducting ring, but this design entails the problem of abrasion between the brush and the conducting part. For another example, the ultrasonic vibration machining apparatus in US 20110155407A1 includes a structure of many sets of gears and wire, which can cause danger in that the wire can twist with the inner elements of the apparatus in a rotary machining process.

Therefore, in order to solve the above-mentioned problems, a structure of the ultrasonic machining apparatus allowing simultaneous rotation and vibration is necessary.

### SUMMARY OF THE INVENTION

A primary object of the present invention is to provide an interface apparatus of transmission used in an ultrasonic machining apparatus.

Another primary object of the present invention is to provide an ultrasonic machining apparatus.

To achieve the above-mentioned primary object, the interface apparatus of transmission of the present invention includes a fixed ring used to connect to the piezoelectric vibration device; a plurality of rotary bearing objects; and a rotary ring connected to the cutting tool, wherein the plurality of rotary bearing objects are set between the rotary ring and the fixed ring.

According to one embodiment of the present invention, the inner diameter of the fixed ring is substantially equal to the inner diameter of the rotary ring.

According to one embodiment of the present invention, the plurality of rotary bearing objects are steel balls.

To achieve another object, the ultrasonic machining apparatus of the present invention includes a cutting tool, a vibration device and an interface apparatus of transmission comprising a fixed ring used to connect the vibration device, a plurality of rotary bearing objects and a rotary ring connected to the cutting tool, wherein the plurality of rotary bearing objects are set between the rotary ring and the fixed ring.

According to one embodiment of the present invention, the inner diameter of the fixed ring is substantially equal to the inner diameter of the rotary ring.

According to one embodiment of the present invention, the vibration device is a piezoelectric vibration device.

According to one embodiment of the present invention, the plurality of rotary bearing objects are steel balls.

### BRIEF DESCRIPTION OF THE DRAWINGS

FIG. 1 presents a cross-sectional drawing of the ultrasonic machining apparatus of the present invention.

FIG. 2 presents an exploded perspective view of the present invention, which shows a vibration device, an interface apparatus of transmission and a cutting tool.

FIG. 3 presents an exploded perspective view of the interface apparatus of the present invention.

### DETAILED DESCRIPTION OF THE PREFERRED EMBODIMENT

To clarify the above and other purposes, features, and advantages of this invention, a preferred embodiment of this invention is especially listed and described in detail with the attached figures as follows.

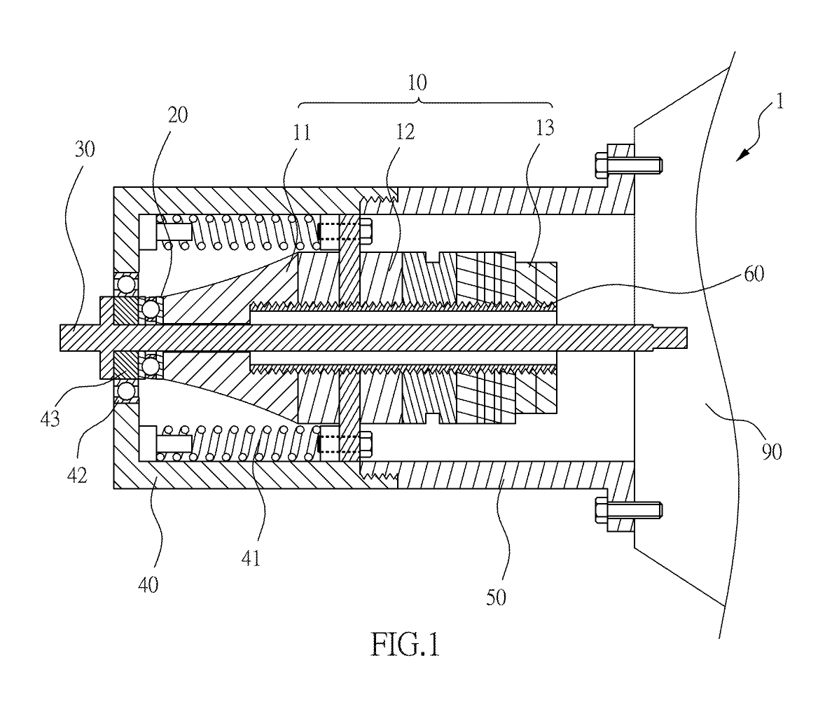

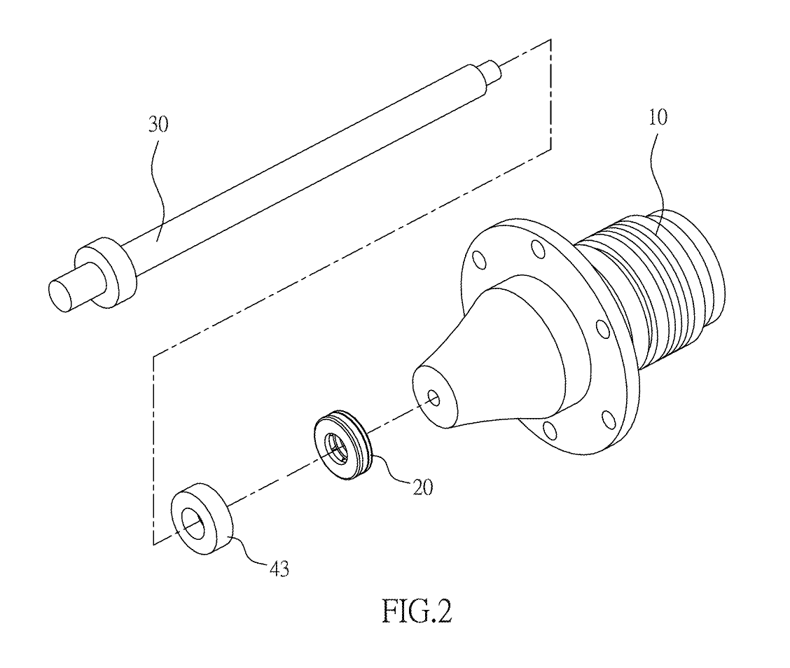

Please refer to FIG. 1 and FIG. 2. The ultrasonic machining apparatus 1 of the present invention mainly comprises a vibration device 10, an interface apparatus of transmission 20 and a cutting tool 30. The end of the cutting tool is fastened to the rotary joint of a machining apparatus 90 so as to conduct rotary machining.

The method of fastening the rotary joint and the cutting tool is a prior art, so detailed description is omitted. The connection between the vibration device 10, the interface apparatus of transmission 20, the cutting tool 30 and other surrounding units will be described in detail below.

The vibration device 10, which is a common ultrasonic vibration device, includes an ultrasonic horn 11, a piezoelectric ring 12 and a fastening nut 13. The elements mentioned above are fastened together via an inner lock machinery 60. According to an embodiment, the inner lock machinery 60 is a sleeve with threads.

In a preferred embodiment, the vibration device 10 relies on a plurality of piezoelectric rings 12 to conduct ultrasonic machining, but the method of vibration is not limited to the preferred embodiment. Because the structure of the ultrasonic vibration device which makes use of the piezoelectric feature to vibrate is not the point of the present invention, it requires no further description.

The other units which are connected to the vibration device 10, the interface apparatus of transmission 20 and the cutting tool 30 include a lower sleeve 40 and an upper sleeve 50. The purpose of the sleeves is to protect the inner elements from being splashed by the machining cooling liquid when the machining apparatus is operating.

The upper sleeve 50 is fastened to the machining apparatus (or the rotary joint of the machining apparatus 90) and the lower sleeve 40 via threads. The inner structure of the lower sleeve 40 includes a pressure distributing device 41, a calibration bearing 42 and a rotary spacer 43. The pressure distributing device 41 is used to increase the stability of the cutting tool through the flexibility of the device when the tool is fastened to the machining apparatus; the rotary spacer 43 is basically fastened with the cutting tool, but it could also be a unity with the cutting tool 30, and the rotary spacer 43 contacts the calibration bearing 42 so as to increase the stability when the cutting tool 30 is rotating.

The other reason why the rotary spacer 43 is set to contact the calibration bearing 42 instead of the cutting tool 30 is to avoid vibration of the cutting tool through direct contact with other units when the rotary machining apparatus is operating.

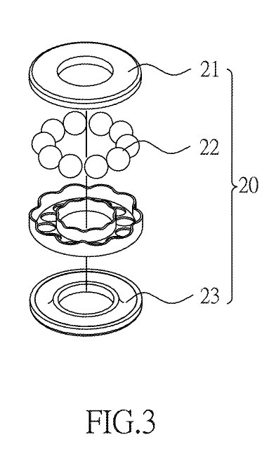

As shown in FIG. 3, the interface apparatus of transmission 20 includes a fixed ring 21, rotary bearing objects 22 and a rotary ring 23, wherein the fixed ring 21 is used to connect to the ultrasonic horn 11. The connection way could be screw fastening (not shown) or other appropriate methods. The rotary bearing objects 22 are set between the rotary ring 23 and the fixed ring 21, and the location of each bearing object is set in a specific element (e.g., the ring with holes shown in FIG. 3).

The rotary ring 23 is installed on the spacer, and the ring rotates with the spacer and the cutting tool via the rotary joint of the machining apparatus 90. The vibration device 10 and the above-mentioned sleeve elements remain in a fixed state. The size of the fixed ring 21 and the size of the rotary ring 23 are substantially the same so as to enclose the rotary bearing objects 22. Therefore, the inner diameters of the two rings are substantially the same as well, but the design is not thus limited.

In the preferred embodiment, the rotary bearing objects 22 are a plurality of steel balls. It should be noted that, although the interface apparatus of transmission 20 is actually a common ball bearing, the idea of using ball bearings to transmit the rotation of an ultrasonic machining apparatus and the vibration of a vibration device is novel in the design of a general ultrasonic machining apparatus.

In this way, the interface apparatus of the transmission can effectively transmit the generated vertical displacement to the rotary cutting tool of an ultrasonic machining apparatus. Users do not need to worry about the transmission wires becoming twisted in a rotation process or the abrasion caused by contact between a piezoelectric ring and a brush.

It should be noted that, although a preferred embodiment of the present invention has been shown and described, the present invention is not limited to the described exemplary embodiment. Instead, it will be appreciated by those skilled in the art that changes may be made to this exemplary embodiment without departing from the principles and spirit of the invention, the scope of which is defined by the claims and their equivalents.

What is claimed is:

1. An interface apparatus of transmission which is installed in an ultrasonic machining apparatus comprising a cutting tool and a piezoelectric vibration device comprising:
a fixed ring used to connect to the piezoelectric vibration device;
a plurality of rotary bearing objects; and
a rotary ring connected to the cutting tool, wherein the plurality of rotary bearing objects are set between the rotary ring and the fixed ring.

2. The interface apparatus of transmission as claimed in claim 1, wherein the inner diameter of the fixed ring is substantially equal to the inner diameter of the rotary ring.

3. The interface apparatus of transmission as claimed in claim 1, wherein the plurality of rotary bearing objects are steel balls.

4. The interface apparatus of transmission as claimed in claim 2, wherein the plurality of rotary bearing objects are steel balls.

5. An ultrasonic machining apparatus which comprises a cutting tool, a vibration device and an interface apparatus of transmission comprising:
a fixed ring used to connect the vibration device;
a plurality of rotary bearing objects; and
a rotary ring connected to the cutting tool, wherein the plurality of rotary bearing objects are set between the rotary ring and the fixed ring.

6. The ultrasonic machining apparatus as claimed in claim 5, wherein the inner diameter of the fixed ring is substantially equal to the inner diameter of the rotary ring.

7. The ultrasonic machining apparatus as claimed in claim 5, wherein the vibration device is a piezoelectric vibration device.

8. The ultrasonic machining apparatus as claimed in claim 5, wherein the plurality of rotary bearing objects are steel balls.

9. The ultrasonic machining apparatus as claimed in claim 6, wherein the plurality of rotary bearing objects are steel balls.

10. The ultrasonic machining apparatus as claimed in claim 7, wherein the plurality of rotary bearing objects are steel balls.
